(19) United States
(12) Patent Application Publication
(10) Pub. No.: US 2002/0149599 A1
(43) Pub. Date: Oct. 17, 2002

(54) Methods and apparatus for displaying multiple data categories

(75) Inventors: David B. Dwyer, Scottsdale, AZ (US); Michelle J. Covert, Phoenix, AZ (US); Aaron J. Gannon, Anthem, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 09/833,944

(22) Filed: Apr. 12, 2001

(51) Int. Cl. G09G 5/02

(52) U.S. Cl. 345/592

(57) ABSTRACT

Methods and apparatus are provided for displaying multiple data categories. The apparatus is comprised of a display that is configured to produce visual representations of the plurality of data categories and a processor that is configured to control the display such that at least one of three display modes is provided for the visual representations of the plurality of data categories. The first display mode provided by the apparatus and method is a transparency mode for at least one of the visual representations of one of the data categories and the second display mode provided by the apparatus and method is a dynamic layering mode for the visual representations of the plurality of data categories. The third display mode is a color prioritization mode for at least three of the visual representations of three of the data categories. One or more of these display modes presents visual representations of the plurality of data categories with the display in a manner that assists cognitive mapping between the display and the user and/or operator of the display and/or reduces the effort of the user and/or operator of the display in assimilating at least one data category of interest.

### BACKGROUND OF THE INVENTION

The present invention generally relates to displaying multiple data categories, and more particularly to methods and apparatus for displaying multiple data categories.

A display provides a visual presentation of information. This visual presentation of information with a display can include multiple data categories. For example, multiple data categories corresponding to sensors and systems of a vehicle can be visually presented to a vehicle operator with a display. The multiple data categories can be any number of classes or divisions in a classification scheme of information that are to be visually represented on a display such as navigation data (e.g., navigation aid or NAVAID data, airport data, fix data, lateral/vertical/time flight plan route data, communication frequency data, latitude and longitude data, Grid Minimum Off-Route Altitude (Grid MORA) data, air traffic control and boundary data, magnetic variation data, time zone data, approach and departure chart data, airport diagram data, city data, road data, railroad data, elevation contour line data, river data, lake data, uplink weather data, winds aloft data, airspace data, airway data and absolute terrain data, or the like) and sensor data (e.g., airborne weather data, Automatic Dependent Surveillance—Broadcast (ADS-B) data, obstacle data, traffic sensor data or Traffic alert and Collision Avoidance System (TCAS), relative terrain data and Enhanced Ground Proximity Warning System (EGPWS) data) of an aircraft.

Displays have continued to advance in sophistication and have achieved increasingly higher levels of information density that enable the visual presentation of a greater number of data categories, which is also referred to as data fusion. These advancements provide the visual display of multiple data categories that can be readily assimilated by an operator and/or user of the display and can also provide a reduction in unnecessary information to ease the task of perceiving and understanding a data category of interest. However, as the information density continues to increase, methods and apparatus are desirable that visually display the data categories in a manner that provides proper cognitive mapping between the operator and/or user of a display and also reduces the effort of the operator and/or user in assimilating one or more of the data categories of interest.

In view of the foregoing, it should be appreciated that it would be desirable to provide an apparatus for displaying multiple data categories. In addition, it should be appreciated that it would be desirable to provide a method for displaying multiple data categories. Furthermore, additional desirable features will become apparent to one skilled in the art from the drawings, foregoing background of the invention, following detailed description of a preferred exemplary embodiment and appended claims.

### BRIEF SUMMARY OF THE INVENTION

An apparatus and method are provided for displaying a plurality of data categories. The apparatus is comprised of a display that is configured to produce visual representations of the plurality of data categories and a processor that is configured to control the display such that at least one of three display modes is provided for the visual representations of the plurality of data categories. The first display mode provided by the apparatus and method is a transparency mode for at least one of the visual representations of one of the data categories. The second display mode provided by the present apparatus and method is a dynamic layering mode for the visual representations of the plurality of data categories. The third display mode is a color prioritization mode for at least three of the visual representations of three of the data categories. One or more of these display modes presents visual representations of the plurality of data categories with the display in a manner that assists cognitive mapping between the display and the user and/or operator of the display and/or reduces the effort of the user and/or operator of the display in assimilating at least one data category of interest.

### BRIEF DESCRIPTION OF THE DRAWINGS

The present invention will hereinafter be described in conjunction with the appended drawing figures, wherein like numerals denote like elements, and:

FIG. 1 is a an apparatus for displaying a plurality of data categories according to a preferred exemplary embodiment of the present invention;

FIG. 2 is the display of FIG. 1 in a first display mode according to a preferred exemplary embodiment of the present invention;

FIG. 3 is an enlarged area of the display of FIG. 2 in the first display mode at various levels of transparency according to a preferred exemplary embodiment of the present invention;

FIG. 4 is the display of FIG. 1 in a default mode of the second display mode according to a preferred exemplary embodiment of the present invention;

FIG. 5 is the display of FIG. 1 in an altered mode of the second display mode according to a preferred exemplary embodiment of the present invention;

FIG. 6 is the display of FIG. 1 in a third display mode according to a preferred exemplary embodiment of the present invention; and

FIG. 7 is the Commission International de l'Eclairage (CIE) Uniform Chromaticity-Scale (UCS) of nineteen hundred and seventy-six (1976).

### DETAILED DESCRIPTION OF A PREFERRED EXEMPLARY EMBODIMENT

The following detailed description of a preferred embodiment is merely exemplary in nature and is not intended to limit the invention or the application and uses of the invention.

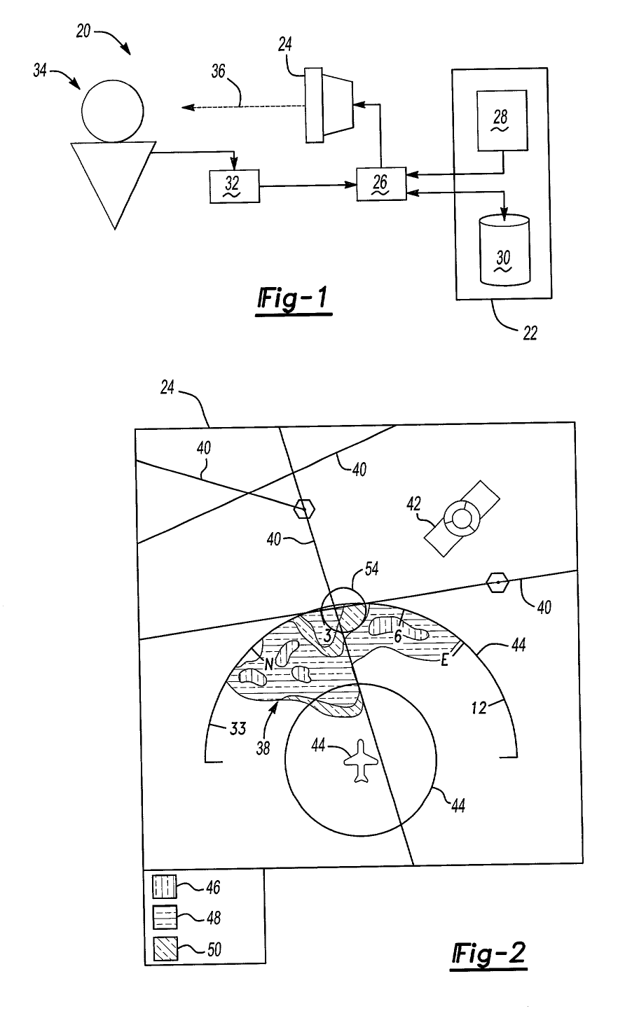

Referring to FIG. 1, an apparatus 20 is illustrated for displaying data categories 22 according to a preferred exemplary embodiment of the present invention. The apparatus 20 is comprised of a display 24 that is configured to produce visual representations of the data categories 22. The display 24 can be any current and future display that is suitable for producing visual representations of the data categories 22 and preferably a multi-color display. For example, the display 22 can be a color Cathode Ray Tube display (CRT), monochrome CRT display, Liquid Crystal Display (LCD), plasma display, Flat-Panel Display (FPD), electro-luminescent display, vacuum fluorescent display, Heads-Up Display (HUD), Heads-Down Display (HDD), Helmet Mounted Display (HMD), Light Emitting Diode (LED) display or the like.

In addition to the display 24, the apparatus 20 of the present invention is also comprised of a processor 26 in operable communication with the display 22 to control the display 24 during production of the visual representations of the data categories 22. The processor 26 preferably encompasses one or more functional blocks and can include any number of individual microprocessors, memories, storage devices, interface cards, and other processor components. The processor 26 is configured to receive and/or access the data categories 22 and also communicate with an input device 32, which can be any device suitable for accepting input from a user 34, such as a cursor control device (e.g., touch-pad, joystick, mouse, trackball), for example. The user 34 (e.g., an aircraft pilot and/or navigator) preferably provides input to the processor 26 with the input device 32 and receives visual feedback 36 from the display 24 of the data categories 22.

The data categories 22 can be any number of classes or divisions in a classification scheme of information. For illustrative purposes only, the data categories 22 in this detailed description of a preferred exemplary embodiment will be sensor data 28 and navigation data 30 of an aircraft (not shown). However, any number of data categories can be visually presented according to the present invention in addition to sensor data 28 and navigation data 30 of an aircraft. The sensor data 28 can be comprised of data categories such as airborne weather data, Automatic Dependent Surveillance—Broadcast (ADS-B) data, obstacle data, traffic sensor data or Traffic alert and Collision Avoidance System (TCAS), relative terrain data and Enhanced Ground Proximity Warning System (EGPWS) data, and the navigation data 30 can be comprised of data categories such as navigation aid or NAVAID data, airport data, fix data, lateral/vertical/time flight plan route data, communication frequency data, latitude and longitude data, Grid Minimum Off-Route Altitude (Grid MORA) data, air traffic control and boundary data, magnetic variation data, time zone data, approach and departure chart data, airport diagram data, city data, road data, railroad data, elevation contour line data, river data, lake data, uplink weather data, winds aloft data, airspace data, airway data and absolute terrain data, or the like. In addition, while the following detailed description of a preferred exemplary embodiment is directed to a display of an aircraft and more particularly to a navigational display or Multi-Function Display (MFD) of an aircraft, the present invention is applicable to other displays in an aircraft and displays for other land, water, air or space vehicles. Furthermore, the present invention is also applicable in non-vehicle applications. For example, the present invention is applicable to simulators, Computer Aided Design (CAD) systems, video games, control systems of stationary objects, medical diagnostic devices, weather forecasting systems and laptop and desktop computers that utilize a display for visual presentation of data categories (i.e., data fusion).

The processor 26 is configured to control the display 24 such that at least one of three display modes is provided for the visual representations of the data categories 22. The first display mode is preferably a transparency mode for at least one visual representation of one of the data categories 22, the second display mode is preferably a dynamic layering mode for at least two of the visual representations of two of the data categories 22, and the third display mode is preferably a color prioritization mode for at least three of the visual representations of three of the data categories 22. One or more of these display modes presents visual representations of the data categories to the user 34 in a manner that preferably assists with the cognitive mapping between the display 24 and the user 34 and/or reduces the time, error and/or effort of the user 34 in assimilating at least one data category of interest.

Referring to FIG. 2, the display 24 is shown in the first display mode (i.e., transparency mode) according to a preferred exemplary embodiment of the present invention. In order to maintain simplicity and clarity in this detailed description of a preferred exemplary embodiment, the display 24 is illustrated with visual representations of four data categories (i.e., data fusion of four data categories). More specifically, visual representations of weather sensor data 38, airway data 40, airspace data 42 and compass heading data 44 is produced by the display 24 under the control of the processor 26 as shown in FIG. 1. However, any number of visual representations of aircraft data categories can be produced on the display and other data categories in other vehicle and non-vehicle applications can be produced on the display 24 as previously discussed in this detailed description of a preferred exemplary embodiment (e.g., data categories of other land, water, air or space vehicles and non-vehicle applications such as simulators, Computer Aided Design (CAD) systems, video games, control systems of stationary objects, medical diagnostic devices, weather forecasting systems and laptop and desktop computers that utilize a display for visual presentation of data categories).

The processor 26 as shown in FIG. 1 is configured to control the display 24 during production of the visual representations of weather sensor data 38, airway data 40, airspace data 42 and compass heading data 44. The processor 26 as shown in FIG. 1 is configured to control the visual representations of the data categories (38,40,42,44) such that the visual representation of weather sensor data 38 is at least partially transparent to provide at least partial visibility of at least one of the other visual representations of data categories (40,42,44) through the visual representation of the weather sensor data 38. More preferably, the processor as shown in FIG. 1 is configured to control the visual representations of the data categories (38,40,42,44) such that the visual representation of weather sensor data 38 is at least partially transparent to provide at least partial visibility of more than one of the other visual representations of the other data categories (40,42,44) through the visual representation of the weather sensor data 38.

More specifically, the visual representation of weather sensor data 38 is preferably superimposed over the visual representations of the airway data 40, airspace data 42 and compass heading data 44. The visual representation of weather sensor data 38 is superimposed with a first transparent color (e.g., transparent red) 46 for high intensity weather, a second transparent color (e.g., transparent yellow) 48 for intermediate intensity weather and a third transparent color (e.g., transparent green) 50 for low intensity weather. The at least partial transparency of the visual representation of weather sensor data 38 provides at least partial visibility of the other data categories (40,42,44) in regions of the display 24 in which the visual representation of weather sensor data 38 intersects (i.e., shares a common region) with one or more of the other visual representations of data categories (40,42,44).

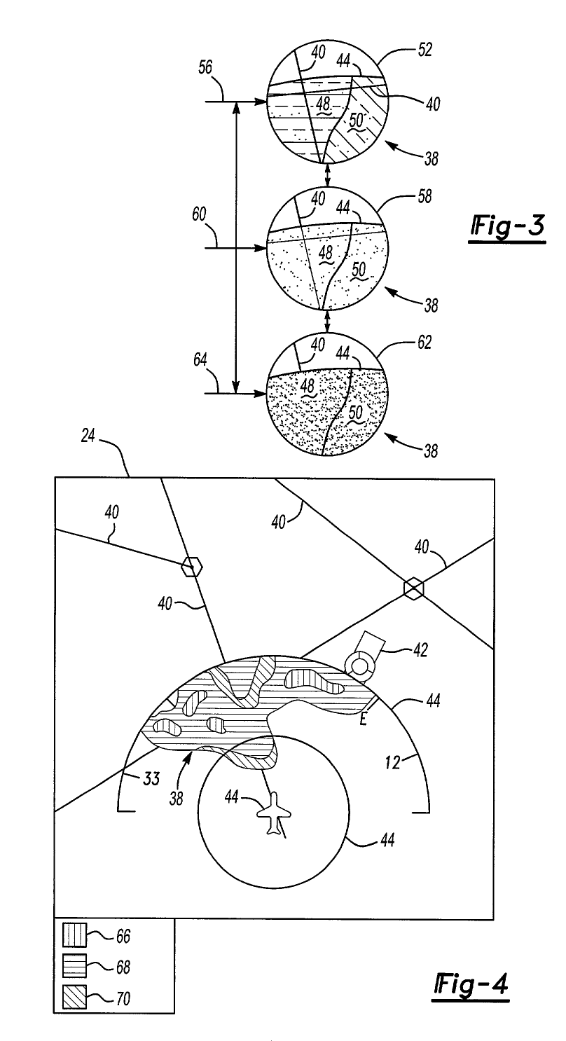

Referring to FIG. 3, a first enlarged view 52 of a region 54 of FIG. 2 is shown. The first enlarged view 52 illustrates the visual representation of the weather sensor data 38 that is preferably produced at a first transparency level 56, which provides a first level of transparency of the visual representation of weather sensor data 38 and a first level of visibility of the visual representation of airway data 40 and preferably the other visual representations of data categories in common regions of the display. The processor 26 as shown in FIG. 1 is also configured to control the display 24 of FIG. 1 for production of additional transparency levels that provide additional levels of transparency of the visual representation for the weather sensor data 38 and additional levels of visibility for the airway data 40 and preferably the other categories (e.g., airspace data 42 and compass heading data 44) in common regions of the display. For example, a second enlarged view 58 of the region 54 of FIG. 2 is shown with the visual representation of the weather sensor data 38 produced at a second transparency level 60 that provides a second level of transparency of the visual representation for the weather sensor data 38, which is about less than the first transparency level 56 and a second level of visibility of the visual representation for the airway data 40 that is about less than the first level of visibility. Furthermore, as shown in the third enlarged view 62 of the region 54 of FIG. 2, the visual representation for the weather sensor data 38 is produced at a third transparency level 64 that provides a third level of transparency of the visual representation of weather sensor data 38 that is about less than the second transparency level 60 and a third level of visibility of the visual representation for airway data 40, which is about less than the second level of visibility. In addition, any number of other transparency levels can be produced with degrees of transparency and visibility greater than and/or less than the first transparency level 56, second transparency level 60 and third transparency level 64.

Referring to FIG. 1, the first transparency level 56, second transparency level 60 and third transparency level 64 illustrated in FIG. 3, or some other transparency level, is preferably selected by the user 34. For example, the user 34 can select one of the transparency levels (56,60,64) illustrated in FIG. 3 using any number of input devices in operable communication with the processor 26, such as a virtual control formed of the cursor control device 32 and a graphical user interface (GUI) (not shown) generated on the display24, for example. Alternatively, one of the transparency levels (56,60,64) illustrated in FIG. 2, or some other transparency level, can be selected based upon other non-user inputs of the apparatus 20. For example, the transparency levels (56,60,64) illustrated in FIG. 2, or some other transparency level, can be selected based upon sensor data 28 (e.g., relative terrain data). Therefore, the transparency mode can be selected by the user 34 or the apparatus 20 to provide transparency levels of one or more of the data categories 22 that assists the cognitive mapping between the display 24 and the user 34 and/or reduces the time, errors and/or effort of the user 34 in assimilating at least one of the data categories 22 of interest. As previously alluded in the brief summary of the invention, the transparency mode can assist in the cognitive mapping and data assimilation without additional display modes or with additional display modes, such as the dynamic layering display mode.

Referring to FIG. 4, the display 24 is shown in a default mode of the dynamic layering mode (i.e., second display mode) according to a preferred exemplary embodiment of the present invention. In order to continue the simplicity and clarity in this detailed description of a preferred exemplary embodiment, the display 24 is illustrated with the visual representation of four data categories (i.e., data fusion of four data categories). More specifically, the visual representations of weather sensor data 38, airway data 40, airspace data 42 and compass heading data 44 is produced by the display 24 under the control of the processor 26 as shown in FIG. 1. However, as previously discussed in this detailed description of a preferred exemplary embodiment, any number of visual representations of aircraft data categories can be produced on the display 24 and other data categories in other vehicle and non-vehicle applications can be produced on the display 24 (e.g., data categories of other land, water, air or space vehicles and non-vehicle applications such as simulators, Computer Aided Design (CAD) systems, video games, control systems of stationary objects, medical diagnostic devices, weather forecasting systems and laptop and desktop computers that utilize a display for visual presentation of data categories).

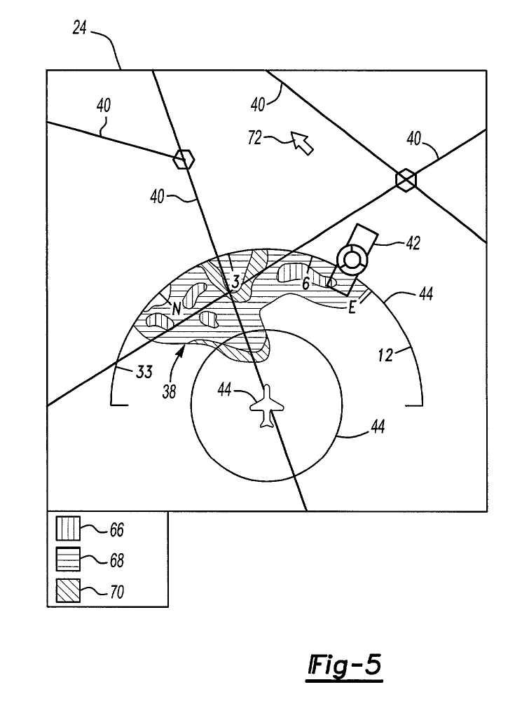

The processor 26 as shown in FIG. 1 is configured to control the display 24 as shown in FIG. 1 during production of the visual representation of weather sensor data 38 that is superimposed over at least one of the visual representations of the airway data 40, airspace data 42 and compass heading data 44 (i.e., the visual representation of weather sensor data 38 masks the visual representations of the airway data 40, airspace data 42 and compass heading data 44 in common regions of the display). The processor 26 as shown in FIG. 1 is also configured to provide an altered mode of the display 24 that alters the visual representations of the data categories (38,40,42,44) such that at least one or more of the visual representations of airway data 40, airspace data 42 and compass heading data 44 is superimposed over the weather sensor data 38 as shown in FIG. 5 (i.e., the visual representation of at least one or more of the visual representations of airway data 40, airspace data 42 and compass heading data 44 masks the visual representation of the weather sensor data 38 in common regions of the display). The processor 26 as shown in FIG. 1 is configured to provide the default mode and altered mode based upon predefined events.

More specifically and with continuing reference to FIG. 4, the visual representation of weather sensor data 38 is preferably superimposed over the visual representation of the airway data 40, airspace data 42 and compass heading data 44 in the default mode of the dynamic layering mode. In this illustrative example, which should not be construed as a limiting embodiment of the invention, the visual representation of weather sensor data 38 is superimposed with a first color (e.g., red color) 66 for high intensity weather, a second color (e.g., yellow color) 68 for intermediate intensity weather and a third color (e.g., green color) 70 for low intensity weather. The first color 66, second color 68 and third color 70 providing the visual representation of weather sensor data 38 substantially reduces or eliminates the visibility of the one or more of the other data categories (40,42,44) in common or intersecting regions of the display 24 more than one of the other visual representations of data categories (40,42,44). As can be appreciated from this description of a preferred exemplary embodiment of the present invention, this default mode of the dynamic layering mode assists the cognitive mapping between the display 24 and the user and/or reduces the time, error and/or effort of the user in assimilating a data category of interest (e.g., the visual representation of weather sensor data 38 as the data category of interest). However, the data category of interest to the user 34 can change based upon the task of the user 34, therefore the processor is configured to provide the altered mode of the display 24, which alters the visual presentations of data categories (38,40,42,44) upon identification of the predefined event to assist in the cognitive mapping between the display and the user and/or reduce the time, error and/or effort of the user in assimilating a data category of interest other than the data category of interest in the default mode.

Referring to FIG. 5, the display 24 is shown in an altered mode of the second display mode (i.e., dynamic layering mode) according to a preferred exemplary embodiment of the present invention. The processor 26 as shown in FIG. 1 is configured to alter the visual representation of the data categories (38,40,42,44) on the display 24. In this detailed description of a preferred exemplary embodiment, the visual representations of the airway data 40, airspace data 42 and compass heading data 44 are superimposed over the weather sensor data 38 (i.e., the visual representations of the airway data 40, airspace data 42 and compass heading data 44 masks the visual representation of the weather data). However, the altered mode of the second display mode can be configured to superimpose a single data category or any subset of the data categories and additional altered modes of the second display mode can be provided under the control of the processor to superimpose any number of data category variations over other data categories or data category upon identification of the predefined event or other predefined events.

Referring to FIG. 1, the predefined event or predefined events identified for configuration of the default mode or any number of altered modes can be an action of the user 34. For example, the processor 26 can be configured to control the display 24 in order to provide the default mode of the second display mode as illustrated in FIG. 4 until the processor 26 identifies the user 34 moving a cursor 72 (FIG. 5) onto the display 24 using any number of input devices in operable communication with the processor 26, such as the cursor control device 32. Upon identification of the movement of the cursor 72 (FIG. 5) onto the display 24, the processor 26 can be configured to control the display 24 in order to provide the altered mode of the second display mode as illustrated in FIG. 5. Alternatively, the processor 26 can be configured to control the display 24 in order to provide the default mode of the second display mode as illustrated in FIG. 4 until the processor identifies a non-user input. For example, the processor 26 can be configured to control the display 24 in order to provide the default mode of the second display mode as illustrated in FIG. 4 until the processor identifies a predefined event in the sensor data 28 (e.g., relative terrain data indicates that the distance between the aircraft and the terrain is less than a predefined distance) at which time the processor 26 controls the display 24 to provide the default mode of the second display mode as illustrated in FIG. 5. Therefore, the default mode and altered mode or altered modes of the dynamic layering mode can be selected by the user 34 or the apparatus 20 to provide a visual representation of one or more of the data categories 22 that assists the cognitive mapping between the display 24 and the user 34 and/or reduces the time, error and/or effort of the user 34 in assimilating at least of the data categories 22 of interest. As previously alluded in the brief summary of the invention and this detailed description of a preferred exemplary embodiment, the dynamic layering mode can assist in the cognitive mapping and data assimilation without additional display modes or with additional display modes, such as the transparency mode and/or the color prioritization mode.

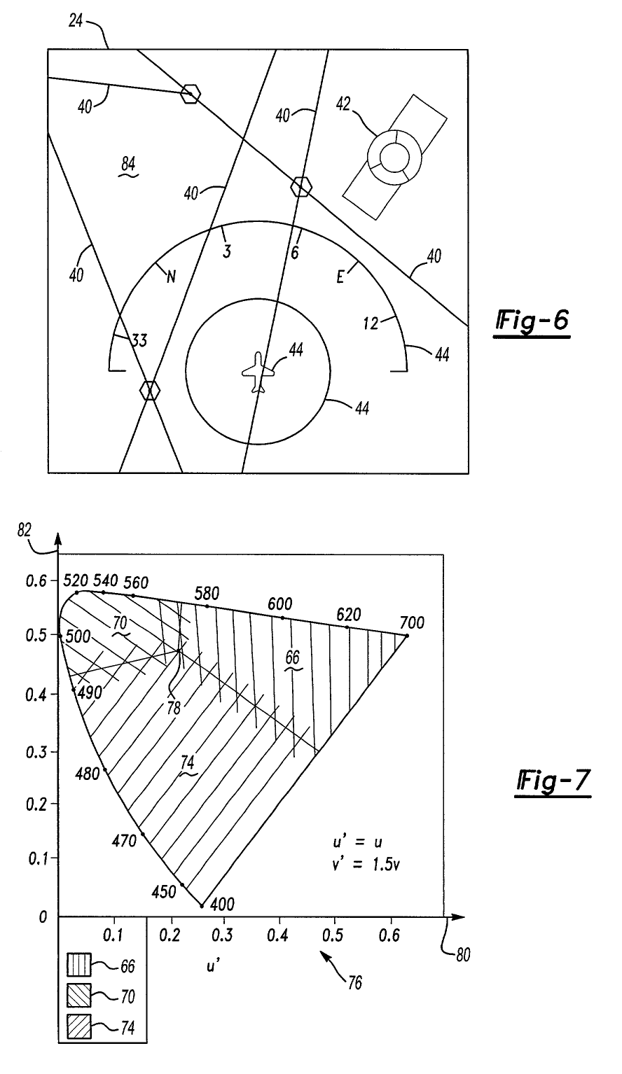

Referring to FIG. 6, the display 24 is illustrated in the color prioritization mode (i.e., third display mode) according to a preferred exemplary embodiment of the present invention. In order to maintain the simplicity and clarity in this detailed description of a preferred exemplary embodiment, the display 24 is illustrated with the visual representation of three data categories (i.e., data fusion of three data categories). More specifically, the visual representation of airway data 40, airspace data 42 and compass heading data 44 is produced by the display 24 under the control of the processor 26 as shown in FIG. 1. However, as previously discussed with reference to the first display mode and the second display mode, any number of visual representations of aircraft data categories can be produced on the display 24 and data categories in other vehicle and non-vehicle applications can be produced on the display 24 in accordance with the present invention (e.g., data categories of other land, water, air or space vehicles and non-vehicle applications such as simulators, Computer Aided Design (CAD) systems, video games, control systems of stationary objects, medical diagnostic devices, weather forecasting systems and laptop and desktop computers that utilize a display for visual presentation of data categories)..

The processor 26 as shown in FIG. 1 is configured to control the display 24 during production of the visual representation of airway data 40, airspace data 42 and a background 84 of the display 24 such that a first color is provided for the airway data 40 that corresponds to a first priority, a second color is provided for the airspace data 42 that corresponds to a second priority and a background color is provided for the background 84 of the display with the color difference (ΔE) between the first color and the background color greater than about seventy-five (75), more preferably greater than about ninety (90) and most preferably greater than about one hundred (100), and the color difference (ΔE) between the second color and the background color is less than about seventy-five (75), more preferably less than about ninety (90) and most preferably less than about one hundred (100). The first priority is preferably selected for the data category or data categories for which a greater amount of attention is to be drawn from the user with the display 24 as compared to the amount of attention to be drawn from the user with the data category or data categories of the second priority. More specifically, the first color, second color and background color are preferably selected so that data category or data categories with the greatest priority are provided with the greatest amount of contrast between the data category and the background 84 of the display 24 and the data category or data categories with a priority less than the greatest priority are provided with less amount of contrast between the data category and the background 84 of the display 24. While the detailed description of a preferred exemplary embodiment provide for a first priority and second priority, any number of priorities with a single data category or multiple data categories can be provided in accordance with the present invention.

Referring to FIG. 7, the Commission International de l'Eclairage (CIE) Uniform Chromaticity-Scale (UCS) of nineteen hundred and seventy-six diagram (1976) 76 is shown that presents color space of a first color (e.g., red 66), second color (e.g., green) 70 and third color (e.g., blue) 74 in terms of luminance (Y), a first chromaticity coordinate (u′) 80 and a second chromaticity coordinate (v′) 82, where chromaticity (u′,v′) is the measure of hue and saturation, hue is related to the wavelength of the color and is represented by the coordinates on the CIE UCS diagram 76, saturation is represented by the relative distance from the center or equal energy point 78 and luminance (Y) is the achromatic aspect of a color stimulus. The three quantities of CIE UCS color space (i.e., Y, u′, v′) are used to define chromatic and achromatic aspects of a color stimulus and provide a replicable description of colors.

The three quantities of CIE UCS color space (i.e., Y, u′, v′) are utilized in accordance with the present invention to select the first color and the second color. The first color and the second color for the respective data category are selected based upon the symbol and background contrast recommendations of the International Organization for Standardization with the following equation:

ΔE(Y,u′,v′)=[(155 ΔY/Yₘₐₓ)²+(367 Δu′)²+(167 Δv′)²]^{½} (1)

Where the differential values (i.e., ΔY, Δu′ and Δv′) relate the differences between the chromaticity (u′,v′) and luminance (Y) of two colors and Yₘₐₓ is the maximum luminance of the display. However, the first color and second color for the respective data category can be selected based upon other considerations or recommendations.

The first color for the first data category having the first priority can be selected with equation (1) such that the color difference (ΔE) between the first color and the background color is preferably greater than about seventy-five (75), more preferably greater than about ninety (90) and most preferably greater than about one hundred (100), while the second color for the second data category having the second priority can be selected with equation (1) such that the color difference (ΔE) between the second color and the background color is preferably less than about seventy-five (75), more preferably less than about ninety (9) and most preferably less than about one hundred (100). This selection of the first color and second color provides color differences between the data categories and the background of the display, which assists in the ability of the user to distinguish between the first data category of the first priority and second data category of the second priority and also draws greater attention to the first data category of the first priority as compared to the attention drawn to the second data category of the second priority. Therefore, the third display mode (i.e., color priority mode) can be utilized to primarily assist in the cognitive mapping between the display and the user and/or reduce the time, error and/or effort of the user in assimilating any number of data categories assigned to any number of priorities of interest or the third display can be utilized in conjunction with the one or more of the other two display modes to assist the user and reduce the time, error and/or effort of the user in assimilating a display with data fusion.

From the foregoing description, it should be appreciated that methods and apparatus are provided for displaying multiple data categories that present significant benefits that have been presented in the background of the invention and detailed description of a preferred exemplary embodiment and also present significant benefits that would be apparent to one or ordinary skill in the art. Furthermore, while a preferred exemplary embodiment has been presented in the foregoing description of a preferred exemplary embodiment, it should be appreciated that a vast number of variations in the embodiments exist. Lastly, it should be appreciated that these embodiments are preferred exemplary embodiments only, and are not intended to limit the scope, applicability, or configuration of the invention in any way. Rather, the foregoing detailed description provides those skilled in the art with a convenient road map for implementing a preferred exemplary embodiment of the invention. It being understood that various changes may be made in the function and arrangement of elements described in the exemplary preferred embodiment without departing from the spirit and scope of the invention as set forth in the appended claims.

What is claimed is:

1. An apparatus for displaying a plurality of data categories, comprising:
a display that is configured to produce a first visual representation of a first data category of the plurality of data categories and a second visual representation of said second data category of the plurality of data categories; and
a processor that is configured to control said display during production of said first visual representation of said first data category and said second visual representation of said second data category such that said first visual representation of said first data category is at least partially transparent to provide at least partial visibility of said second visual representation of said second category through said first visual representation of said first data category.

2. The apparatus of claim 1, wherein said display is configured to produce a third visual representation of a third data category of the plurality of data categories and said processor is configured to control said display during production of said first visual representation of said first data category and said third visual representation of said third data category such that said first visual representation of said first data category is at least partially transparent to provide at least partial visibility of said third visual representation of said third category of data through said first visual representation of said first data category.

3. The apparatus of claim 2, wherein said display is configured to produce a fourth visual representation of a fourth data category of the plurality of data categories and said processor is configured to control said display during production of said first visual representation of said first data category and said fourth visual representation of said fourth data category such that said first visual representation of said first data category is at least partially transparent to provide at least partial visibility of said fourth visual representation of said fourth data category through said first visual representation of said first data category.

4. The apparatus of claim 1, wherein said processor is control said display for production of a plurality of transparency levels providing a plurality of reduced visibilities of said second visual representation of said second data category through said first visual representation of said first data category.

5. The apparatus of claim 1, wherein said plurality of data categories are vehicle data categories.

6. The apparatus of claim 1, wherein said plurality of data categories are aircraft data categories.

7. The apparatus of claim 1, wherein said display is a Multi-Function Display (MFD).

8. The apparatus of claim 1, wherein said first data category is sensor data.

9. The apparatus of claim 1, wherein said second data category is navigation data.

10. An apparatus for displaying a plurality of data categories, comprising:
a display that is configured to produce a first visual layer representation of a first data category of the plurality of data categories and a second visual layer representation of a second data category of said plurality of data categories;
a processor that is configured to control said display to present said first visual representation of said first data category superimposed over said second visual representation of said second data category and superimpose said second visual representation of said second data category over said first visual representation of said first data category if a predefined event is identified by said processor.

11. The apparatus of claim 10, wherein said display is configured to produce a third visual representation of a third data category of the plurality of data categories and said processor is configured to control said display to present said first visual representation of said first data category superimposed over said third visual representation of said third data category and superimpose said third visual representation of said third data category over said first visual representation of said first data category if said predefined event is identified by said processor.

12. The apparatus of claim 11, wherein said display is configured to produce a fourth visual representation of a fourth data category of the plurality of data categories and said processor is configured to control said display to present said first visual representation of said first data category superimposed over said fourth visual representation of said fourth data category and superimpose said fourth visual representation of said fourth data category over said first visual representation of said first data category if said predefined event is identified by said processor.

13. The apparatus of claim 10, wherein said plurality of data categories are vehicle data categories.

14. The apparatus of claim 10, wherein said plurality of data categories are aircraft data categories.

15. The apparatus of claim 10, wherein said display is a Multi-Function Display (MFD).

16. The apparatus of claim 10, wherein said first data category is sensor data.

17. The apparatus of claim 10, wherein said second data category is navigation data.

18. An apparatus for displaying a plurality of data categories, comprising:
a display that is configured to produce a first visual representation of a first data category of the plurality of data categories, a second visual representation of said second data category of the plurality of data categories; and
a processor that is configured to control said display during production of said first visual representation of said first data category, said second visual representation of said second data category such that a first color is provided for said first visual representation of said first data category and a second color is provided for said second visual representation of said second data category that correspond to a first priority for said first color and a second priority for said second color with a first color difference between said first color and a background color of said display greater than about seventy-five and a second color difference between said second color and said background color less than about seventy-five.

19. The apparatus of claim 18, wherein said first color difference is greater than about ninety (90).

20. The apparatus of claim 18, wherein said first color difference is greater than about one hundred (100).

21. The apparatus of claim 18, wherein said second color difference is less than about ninety (90).

22. The apparatus of claim 18, wherein said second color difference is less than about one hundred (100).

23. The apparatus of claim 18, wherein said plurality of data categories are vehicle data categories.

24. The apparatus of claim 18, wherein said plurality of data categories are aircraft data categories.

25. The apparatus of claim 18, wherein said display is a Multi-Function Display (MFD).

26. The apparatus of claim 18, wherein said first data category is sensor data.

27. The apparatus of claim 18, wherein said second data category is navigation data.
